(19) United States
(12) Patent Application Publication
(10) Pub. No.: US 2011/0058127 A1
(43) Pub. Date: Mar. 10, 2011

(54) OPTICAL COMPENSATION SHEET, POLARIZING PLATE, LIQUID CRYSTAL DISPLAY AND METHOD OF MANUFACTURING OPTICAL COMPENSATION SHEET

(75) Inventor: Kentaro Toyooka, Minami-Ashigara-shi (JP)

(73) Assignee: FUJIFILM Corporation, Minato-ku (JP)

(21) Appl. No.: 12/716,025

(22) Filed: Mar. 2, 2010

(30) Foreign Application Priority Data
Mar. 2, 2009 (JP) 2009-048500

(51) Int. Cl. G02F 1/1335; B05D 5/06; B05D 3/06

(52) U.S. Cl. 349/96; 349/117; 427/163.1; 427/547

(57) ABSTRACT

An optical compensation sheet is provided and includes: a transparent substrate; and at least one optical anisotropic layer containing a liquid crystalline compound. The optical compensation sheet has a film contrast value of 4000 or more in which the film contrast value is represented by formula (1).

film contrast value=(maximum luminance of the optical compensation sheet disposed between polarizing plates arranged in a parallel Nichol configuration)/(minimum luminance of the optical compensation sheet disposed between the polarizing plates arranged in a cross Nichol configuration) Formula (1)

This application is based on and claims priority under 35 U.S.C. §119 from Japanese Patent Application No. 2009-48500 filed Mar. 2, 2009, the entire disclosure of which is herein incorporated by reference.

### BACKGROUND OF THE INVENTION

1. Field of the Invention

The present invention relates to an optical compensation sheet applied to a liquid crystal display and a manufacturing method thereof, and a polarizing plate and a liquid crystal display using the optical compensation sheet.

2. Background Art

A liquid crystal device (LCD) has a liquid crystal cell and a pair of polarizing plates sandwiching the cell.

A polarizing plate generally has a protective film formed from cellulose acetate and a polarizer. The polarizing plate is obtained, for example, by dyeing the polarizer of a polyvinyl alcohol film with iodine, stretching the same, and stacking protective films on both surfaces thereof.

With an aim of compensating distortion in images viewed from various view angles due to phase differences of polarized light passing through the liquid crystal cell, one or more retardation films are sometimes disposed in adjacent with the protective film. The retardation film is also referred to as an optical compensation sheet and can be used also as a protective film for a polarizing plate by direct bonding to the polarizer.

The liquid crystal cell conducts ON/OFF displays due to differences in the alignment states (orientation states) of liquid crystalline molecules, and display modes such as TN (Twisted Nematic), IPS (In-Plane Switching), OCB (Optically Compensatory Bend), VA (Vertically Aligned), and ECB (Electrically Controlled Birefringence) have been proposed.

JP-A-8-50206 describes a liquid crystal display of applying an optical compensation sheet as a technique of improving the lowering of contrast when viewed from an oblique direction and gradation inversion that the luminance is inverted in gradation display as a feature of the TN mode liquid crystal display.

While the technique can improve the contrast to some extent, higher contrast has been demanded as the response speed of liquid crystalline molecules of the TN mode liquid crystal cell has become higher and the TN mode liquid crystal cell has been applied also to video images of television, etc.

### SUMMARY OF THE INVENTION

For improving the contrast value on the view side, it is necessary to enhance the alignment of liquid crystalline molecules in the liquid crystal cell or suppressing scattering components of filters for each of red, green, and blue colors.

However, in the case of applying an optical compensation sheet to a liquid crystal display, the contrast property can be improved also by changing the optical property of the optical compensation sheet.

In a case of an optical compensation sheet using a cellulose acetate film as a substrate, coating discotic liquid crystals thereon and fixing the liquid crystals being aligned as described in JP-A-8-50206, it has been found that if the alignment direction of the liquid crystals to be fixed is not uniform, this gives an effect on a contrast.

For making the alignment direction of the liquid crystals uniform, the alignment property of the liquid crystals is an important factor as a matter of course, and this can be attained in two ways, that is, by the effect of an external force from a boundary of the optical anisotropic layer at which the liquid crystals are aligned and by an internal control of the optical anisotropic layer. In the case of the external force, this is attained by the effect of an alignment control force by an alignment layer at the substrate side and by the control of a blowing rate and a blowing direction in a drying step at the air boundary side. Further, in the case of the internal control, the effect to the liquid crystalline molecules can be obtained by a surfactant or another additive. The uniform alignment is enhanced more by combination of them.

An object of an illustrative, non-limiting embodiment of the invention is to provide an optical compensation sheet including a transparent substrate and an optical anisotropic layer where a liquid crystalline compound is fixed while they are aligned, which can enhance the contrast without deteriorating the gradation inversion by making the alignment direction of the liquid crystalline compound uniform. Another object of the invention is to provide a method for manufacturing the optical compensation sheet, and a polarizing and a liquid crystal display using the optical compensation sheet.

According to an aspect of the invention, there is provided the following means.

(1) An optical compensation sheet comprising: a transparent substrate; and at least one optical anisotropic layer containing a liquid crystalline compound, wherein the optical compensation sheet has a film contrast value of 4000 or more, the film contrast value being represented by formula (1).

film contrast value=(maximum luminance of the optical compensation sheet disposed between polarizing plates arranged in a parallel Nichol configuration)/(minimum luminance of the optical compensation sheet disposed between the polarizing plates arranged in a cross Nichol configuration) Formula (1)

(2) The optical compensation sheet as described in (1), wherein a half-width value of an alignment axis distribution of the liquid crystalline compound in a minute region is 3.0° or less.
(3) The optical compensation sheet as described in (1) or (2), wherein the liquid crystalline compound is hybrid-aligned.
(4) The optical compensation sheet as described in any one of (1) to (3), wherein the liquid crystalline compound is a discotic liquid crystal.
(5) The optical compensation sheet as described in any one of (1) to (4), wherein a director tilt angle of the liquid crystalline compound at a transparent substrate side of the optical anisotropic layer is 40° to 75°.
(6) The optical compensation sheet as described in any one of (1) to (4), wherein a director tilt angle of the liquid crystalline compound at a transparent substrate side of the optical anisotropic layer is 0° to 20° and a director tilt angle of the liquid crystalline compound at an air boundary side of the optical anisotropic layer is 30° to 90°.
(7) The optical compensation sheet as described in any one of (1) to (6), further comprising an optical alignment layer between the transparent substrate and the optical anisotropic layer, wherein the liquid crystalline compound is aligned by an alignment control force provided by the optical alignment layer.
(8) The optical compensation sheet as described in any one of (1) to (6), further comprising an inorganic alignment layer between the transparent substrate and the optical anisotropic layer, formed by oblique vapor deposition, wherein the liquid crystalline compound is aligned by the alignment control force.
(9) The optical compensation sheet as described in any one of (1) to (8), wherein the optical anisotropic layer has a thickness of 2.0 μm or more.
(10) A method of manufacturing an optical compensation sheet as described in any one of (1) to (9), comprising:

coating a composition containing a liquid crystalline compound on a substrate having an alignment layer,

keeping the coated composition at a temperature of the liquid crystalline compound forming a liquid crystal phase to align the liquid crystalline compound in an aligned state to form a pre-layer of the optical anisotropic layer;

providing an alignment control force by eternal force on an air boundary side of the pre-layer; and

fixing the liquid crystalline compound in the aligned state to form optical anisotropic layer.

(11) The method as described in (10), wherein the providing of the alignment control force includes applying a uniform blow at a uniform rate of 3.0 m/s in a direction.
(12) A method of manufacturing an optical compensation sheet s described in any one of (1) to (9), comprising:

coating a composition containing a liquid crystalline compound on a substrate having an alignment layer,

keeping the coated composition at a temperature of the liquid crystalline compound forming a liquid crystal phase to align the liquid crystalline compound in an aligned state to form a pre-layer of the optical anisotropic layer;

applying a magnetic field to the pre-layer; and

fixing the liquid crystalline compound in the aligned state to form optical anisotropic layer.

(13) A method of manufacturing an optical compensation sheet s described in any one of (1) to (9), comprising:

coating a composition containing a liquid crystalline compound on a substrate having an alignment layer,

keeping the coated composition at a temperature of the liquid crystalline compound forming a liquid crystal phase to align the liquid crystalline compound in an aligned state to form a pre-layer of the optical anisotropic layer;

causing a temperature difference of 10° C./m or more relative to a transportation direction of the substrate; and

fixing the liquid crystalline compound in the aligned state to form optical anisotropic layer.

(14) A method of manufacturing an optical compensation sheet s described in any one of (1) to (9), comprising:

coating a composition containing a liquid crystalline compound on a substrate having an alignment layer,

keeping the coated composition at a temperature of the liquid crystalline compound forming a liquid crystal phase to align the liquid crystalline compound in an aligned state to form a pre-layer of the optical anisotropic layer; and

fixing the liquid crystalline compound in the aligned state to form optical anisotropic layer,

wherein the temperature in the keeping of the coated composition to align the liquid crystalline compound in the aligned state is 40° C. or lower.

(15) A method of manufacturing an optical compensation sheet s described in any one of (1) to (9), comprising:

coating a composition containing a liquid crystalline compound on a substrate having an alignment layer,

keeping the coated composition at a temperature of the liquid crystalline compound forming a liquid crystal phase to align the liquid crystalline compound in an aligned state to form a pre-layer of the optical anisotropic layer; and

fixing the liquid crystalline compound in the aligned state to form optical anisotropic layer,

wherein the keeping of the coated composition to align the liquid crystalline compound in the aligned state includes: keeping the coated composition for at least 20 sec at T₁ which is a temperature at or higher than a nematic-isotropic phase transition temperature Tᵢₛₒ of the liquid crystal composition; and applying to the coated composition a heat treatment at T₂ lower than Tᵢₛₒ, in this order.

(16) A method of manufacturing an optical compensation sheet s described in any one of (1) to (9), comprising:

coating a composition containing a liquid crystalline compound on a substrate having an alignment layer,

keeping the coated composition at a temperature of the liquid crystalline compound forming a liquid crystal phase to align the liquid crystalline compound in an aligned state to form a pre-layer of the optical anisotropic layer; and

fixing the liquid crystalline compound in the aligned state to form optical anisotropic layer,

wherein the keeping of the coated composition to align the liquid crystalline compound in the aligned state includes: aligning a discotic surface of the liquid crystalline compound substantially horizontally; and changing an alignment direction of the liquid crystalline compound along with a distance between the liquid crystalline compound and the alignment layer.

(17) A polarizing plate comprising an optical compensation sheet as described in any one of (1) to (9).
(18) A liquid crystal display comprising a polarizing plate as described in (17).
(19) The liquid crystal display as described in (18), wherein when a voltage for black display is set to be a voltage at which a transmittance of the liquid crystal display not containing the optical compensation sheet is within 1% to 10% relative to a white luminance in a voltage-transmittance curve of the liquid crystal display not containing the optical compensation sheet, a retardation of the optical compensation sheet and a bonding angle of the optical compensation sheet with a polarizer of the polarizing plate are controlled such that a black luminance is minimized at the voltage for black display.

### DETAILED DESCRIPTION OF EXEMPLARY EMBODIMENTS

According to an exemplary embodiment of the invention, contrast of a liquid crystal display can be enhanced without deteriorating the gradation inversion, for example, by using a specific optical compensation sheet used in the liquid crystal display or by changing the production process for the optical compensation sheet, without improvement for a liquid crystal cell of the liquid crystal display.

An exemplary embodiment of the invention will be described as below.

In the specification, the “alignment control force” means force or action (for example, heat, light, electric filed, magnetic files, force of wind) which is applied directly or indirectly to a liquid crystalline compound so that the liquid crystalline compound is aligned in a certain direction.

### (Optical Compensation Sheet)

An optical compensation sheet of the invention can be formed by coating discotic liquid crystals on a polymer film such as a cellulose acetate film as a substrate and fixing the liquid crystals while aligning them. Liquid crystals can be aligned effectively by coating an alignment layer on the substrate and applying a rubbing treatment to the surface before coating the liquid crystals.

### (Transparent Substrate)

A substrate used in the invention is preferably transparent and, specifically, a transparent polymer film having a light transmittance of 80% or more is preferred. Examples of polymer film usable as the transparent substrate includes cellulose ester (examples: cellulose acetate, cellulose diacetate, cellulose triacetate), cycloolefine polymer, cyclopolyolefinic copolymer, norbornenic polymer, and polymethyl methacrylate. Commercial polymers (Arton (registered trade mark) and Zeonex (registered trade mark), Apel (registered trade mark, etc. as norbornen polymer) may also be used. Further, a film of a cellulose ester is preferred, and a film of a lower fatty acid ester of cellulose is more preferred. The lower fatty acid means an aliphatic acid having 6 or less carbon atoms. Particularly, those having carbon atoms by the number of 2 (cellulose acetate), 3 (cellulose propionate), or 4 (cellulose butyrate) is preferred. A film of cellulose acetate is particularly preferred among the cellulose esters described above. A mixed fatty acid ester such as cellulose acetate propionate or cellulose acetate butyrate can also be used.

Also a polymer tending to develop bire fringence such as a polycarbonate or a polysulfone known so far can also be used as a transparent substrate in the invention by controlling the developability of the birefringence by modifying molecules as described in WO 00/26705.

In a case of using the optical compensation sheet as a protective film for a polarizing plate, it is preferred to use cellulose acetate having a degree of acetylation of 55.0 to 62.5% as the polymer film. The degree of acetylation is more preferably, from 57.0 to 62.0%.

The degree of acetylation means the amount of bonded acetic acid per unit mass of cellulose.

The degree of acetylation is determined by measurement and calculation for the degree of acetylation according to ASTM:D-817-91 (test method for cellulose acetate, etc.).

A viscosity average polymerization degree (DP) of cellulose acetate is preferably 250 or more and, more preferably, 290 or more. Further, it is preferred that cellulose acetate has a narrow molecular weight distribution of Mw/Mn (Mw: mass average molecular weight, Mn: number average molecular weight) according to gel permeation chromatography.

Specific value for Mw/Mn is, preferably, from 1.0 to 40, more preferably, from 1.0 to 1.65, and particularly preferably, from 1.0 to 1.6.

In cellule acetate, hydroxyl groups at 2-position, 3-position and 6-position of cellulose are not substituted equally but the substitution degree at the 6-position tends to be decreased.

In a polymer film used as the transparent substrate, it is preferred that the substitution degree on the 6-position is about identical with or more than that of the 2-position and the 3-position of cellulose.

The ratio of the substitution degree on the 6-position based on the total substitution degrees on the 2-position, 3-position, and the 6-position is preferably 30 to 40%, more preferably, 31 to 40% and, particularly preferably, 32 to 40%. Further, the substitution degree on the 6-position is preferably 0.88 or more. The substitution degree on each position can be measured by NMR.

The cellulose acetate of high substitution degree at the 6-position can be synthesized with reference to the method of Synthesis Example 1 described in paragraphs Nos. (0043) to (0044), Synthesis Example 2 described in paragraphs Nos. (0048) to (0049), and Synthesis Example 3 described in paragraphs Nos. (0051) to (0052) of JP-A-11-5851.

In the present specification, Re, Rth represent each retardation in a plane (in-plane retardation) and retardation in a thickness direction, respectively. In a transparent substrate, Re is preferably from 5 to 100 nm, and Rth is preferably from 30 to 100 nm. Further, in a case of intending to compensate phase differences contained not only in a liquid crystal cell but also in a polarizing plate, Re is preferably from 50 to 100 nm and Rth is preferably from 40 to 80 nm.

### (Alignment Layer)

In an optical compensation sheet of the invention, an alignment layer (orientation layer) can be previously formed on a transparent substrate for forming an optical anisotropic layer formed of a liquid crystal composition containing a liquid crystalline compound on the transparent substrate.

For the alignment layer, a polyvinyl alcohol or a modified polyvinyl alcohol is used usually. In the invention, for improving the contrast, it is preferred to adopt each of methods of alignment providing high alignment control force, optical alignment, uniform hybrid alignment via horizontal alignment, magnetic field alignment, oblique vapor deposition alignment, uniform hybrid alignment via Iso temperature, and change of film thickness, with an aim of exerting an alignment control force more uniformly.

Methods for aligning (orienting) a liquid crystalline compound of the invention will be described.

### (Alignment Layer Providing High Alignment Control Force)

The alignment layer providing high alignment control force is a layer that lowers the alignment axis distribution in the minute region. Examples of a material for the layer includes, preferably, copolymer compounds described in paragraphs (0014) to (0016) in JP-A-2002-98836 and more preferably copolymer compounds described in paragraphs (0024) to (0029) and (0173) to (0180) in JP-A-2002-98836. Other examples of the material for the layer includes, preferably, copolymer compound described in paragraphs (0007) to (0012) in JP-A-2005-99228 and more preferably copolymer compounds described in paragraphs (0016) to (0020) in JP-A-2005-99228. From the viewpoint of improving adhesion property between the alignment layer and the optical anisotropic layer, it is further preferable that the copolymer compounds described in above references has a substituent such as a vinyl group.

### (Optical Alignment)

The optical alignment layer is a layer that develops an alignment function by light irradiation. A material used for forming the optical alignment layer is, preferably, a compound having an optical alignment group that develops the optical alignment function and, for example, compounds having an optical alignment group causing optical isomerization such as an azo group, and compounds having an optical alignment group causing optical dimerization such as a cinnamoyl group, a coumarin group, and a chalcone group are suitable. Further, preferred examples can include also a compound that develops alignment function by photo crosslinking such as a benzophenone group and a compound that develops the alignment function by photodecomposition such as polyimide resins.

The optical alignment layer can be formed by applying a material for an optical alignment layer, for example, a composition containing a compound having an optical alignment group on a transparent substrate. It is preferred to prepare the composition as a coating solution, and coat and dry the same on the surface of a substrate, etc. to form the layer. Specifically, it is formed preferably by dissolving or dispersing a compound having the optical alignment group, etc. in an appropriate solvent to prepare a coating solution and coating and drying the coating solution on a substrate. The coating can be applied by a known method (for example, spin coating, wire bar coating, extrusion coating, direct gravure coating, reverse gravure coating, and die coating).

The thickness of the optical alignment layer is preferably, from 0.01 to 2 μm and, more preferably, from 0.01 to 0.1 μm.

A light source used for light irradiation can include, those light sources used usually, for example, lamps such as tungsten lamp, halogen lamp, xenone lamp, xenone flash lamp, mercury lamp, mercury xenone lamp, and carbon arc lamp, various kinds of lasers (for example, semiconductor laser, helium neon laser, argon ion laser, helium cadmium laser, YAG laser), light emission diodes, and cathode ray tubes. Light may be irradiated as a non-polarized light or a polarized light and in a case of using the polarized light, a linear polarized light is used preferably. Further, only the light of necessary wavelength may be selectively irradiated by using a filter, a wavelength conversion device, etc.

### (Uniform Hybrid Alignment Via Horizontal Alignment)

The method includes a technique described in JP-A-2004-177813. For uniformly aligning liquid crystalline molecules applied to an optical anisotropic layer in a short time, an additive for accelerating horizontal alignment is added to a composition for forming an optical anisotropic layer and, after once aligning the discotic surface horizontally, it is further heated to obtain hybrid alignment. As the horizontal alignment agent, those described in JP-A-2004-177813 can be applied.

Further, steps after the horizontal alignment are attained by adding an energy (heat, light, electric field, magnetic field) from the outside.

The energy from the outside is preferably heat. It is preferred that the heating temperature is a temperature higher than the heating temperature in the step of aligning the liquid crystalline compound substantially horizontally. The heating temperature is preferably at a temperature higher by 5° C. or more and, most preferably at a temperature higher by 10° C. or more than the heating temperature in the step of aligning the liquid crystalline compound substantially horizontally.

### (Oblique Vapor Deposition)

The method is a technique described in JP-A-7-134213, which is herein incorporated by reference. A typical inorganic oblique vapor deposition film is an SiO oblique vapor deposition film, and a rolled sheet can be manufactured by using a continuous oblique vapor deposition apparatus as in FIG. 6 of JP-A-7-134213. The polarization angle y in FIG. 6(b) of JP-A-7-134213 is 0° in usual continuous vapor deposition apparatuses, but it is preferred that this is within a range of: 0°<x<90° in the continuous vapor deposition apparatus. Further, the minimum vapor deposition angle x shown in FIG. 6(a) of JP-A-7-134213 is within a range: 10°<x<88°. By using such vapor deposition apparatus, a rolled sheet having an ability of forming a discotic liquid crystal layer in which the in-plane optical axis direction forms an angle y (0°<y<90°) relative to the longitudinal direction of the roll can be prepared. By the oblique vapor deposition, rod-like vapor deposition particles are grown and formed from the substrate surface toward the direction of the vapor deposition source and, at a vapor deposition angle θ (angle formed between a normal line at a point on a sheet surface and a line connecting the point to a vapor deposition source) of about 65 to 88°, discotic liquid crystals are aligned in a direction where the direction of the column of vapor deposited particles and the optical axis of the discotic liquid crystal are in substantially in perpendicular to each other and, at a vapor deposition angle θ of about 20° to 65°, they are aligned in a direction where the direction of the vapor deposition column and the optical axis of the discotic liquid crystal substantially agree to each other.

A typical organic alignment layer is a fluoropolyimide film. The angle for oblique alignment can be controlled by coating a fluoro-polyamic acid (LQ 1800 manufactured by Hitachi Kasei Co.) to a substrate surface, baking at 200° C. to 300° C. and then applying rubbing. In the invention, since it is necessary to prepare the layer such that the in-plane optical axis direction forms an angle y (0°<y<90° C.) relative to the longitudinal direction of a rolled sheet, a rubbing step in which the rubbing direction forms an angle y relative to the transportation direction of the roll as shown in FIG. 7 of JP-A-7-134213 may be adopted. In the rubbing step, it is defined that the rotational speed of the rubbing roll is sufficiently higher relative to the transportation speed of the roll.

### (Uniform Hybrid Alignment Via Iₛₒ Temperature)

This is a manufacturing method including a heat treatment step of conducting a heat treatment to a transparent substrate coated with two or more kinds of liquid crystalline compounds different in the structure and different in the temperature for nematic to isotropic phase transition temperature respectively, in which the heat treatment step includes a first heat treatment step of keeping a temperature T₁ which is at or higher than the nematic-isotrophic phase transition temperature Tiso of the liquid crystal composition and a second heat treatment step of conducting a heat treatment at a temperature T₂ which is lower than the temperature Tiso after the first heat treatment step.

It is noted in this method that when nematic liquid crystal monomers are hybrid-aligned at a liquid crystal phase temperature and the nematic liquid crystal monomers put to hybrid alignment are fixed by polymerization, the state of the liquid crystal phase and the isotropic phase can be taken by heating also after removing the solvent. Since the liquid crystals are in a state of moving about at random, particularly, in the isotropic state, the viscosity can be lowered and unevenness can be improved easily by leveling.

The heat treatment step includes the first heat treatment step and the second heat treatment step and, optionally, a third heat treatment step.

### —First Heat Treatment Step—

In the first heat treatment, step, a first heat treatment is conducted at a temperature T₁ which is at or higher than the nematic to isotropic phase transition temperature Tᵢₛₒ of the liquid crystal composition.

In a case where the temperature T₁ is at or higher than the nematic-to-isotropic phase transition temperature Tᵢₛₒ of the liquid crystal composition, it is possible to produce an optical compensation sheet with no unevenness and alignment defects at a good productivity. T1 described above has no particular restriction so long as it is a temperature at or higher than Tᵢₛₒ, and can be selected properly in accordance with the purpose. The upper limit for T₁ is preferably at or lower than the thermal polymerization temperature of the liquid crystal composition. A temperature higher than the thermal polymerization temperature is not preferred since the liquid crystals are fixed by polymerizing reaction during the heat treatment.

The retention time of retaining the heat treatment state by the temperature T₁ described above is at least 20 sec, preferably, 30 sec or more and, more preferably, 60 sec or more.

In a case where the retention time is 20 sec or more, unevenness and alignment detects can be suppressed.

The upper limit for the retention time is preferably 120 sec at the longest.

In a case where the retention time exceeds 120 sec, the productivity is lowered.

The heat treatment means in the first heat treatment step has no particular restriction and can be selected properly in accordance with the purpose and includes, for example, a thermostat bath, a heating roll, etc.

### —Second Heat Treatment Step—

In the second heat treatment step, heat treatment is conducted at a temperature T₂ which is lower than Tᵢₛₒ.

It may be suffice that T₂ is at a temperature lower than Tᵢₛₒ and can be selected properly according to the purpose and can be, for example, at a room temperature. It is preferred that the temperature is lower by 1° C. or more than Tᵢₛₒ.

In a case where the difference between T₂ and Tᵢₛₒ is less than 1° C., alignment of the liquid crystalline compound may possibly be hindered when the temperature fluctuates.

The lower limit for the retention time for retaining the heat treatment state at the temperature T₂ is preferably at least for 20 sec.

In a case where the retention time is 20 sec or more, the alignment defects can be suppressed particularly.

The upper limit of the retention time is preferably 120 sec or less.

In a case where the retention time exceeds 120 sec, the productivity is lowered.

The heat treatment means in the second heat treatment step has no particular restriction so long as it can conduct the heat treatment at the temperature T₂ and can be selected properly according to the purpose and includes, for example, a thermostat bath, a heating roll, etc.

### —Third Heat Treatment Step—

Further, succeeding to the second heat treatment step, a heat treatment in the third heat treatment step can also be conducted.

As the third heat treatment step, it is preferred to conduct a heat treatment at a temperature T₃ which is lower than T₂ described above.

It may suffice that T₃ is at a temperature lower than T₂ and can be selected properly according to the purpose and, for example, it can be at a room temperature, and it is preferably at a temperature to form a nematic phase. A temperature for forming a columnar phase or crystal phase is not preferred since the alignment may possibly be disturbed.

The lower limit of the retention time for retaining the heat treatment state at the temperature T₃ described above is preferably at least for 10 sec.

In a case where the retention time is 10 sec or more, the liquid crystal can be controlled to a desired alignment state.

The upper limit of the retention time is preferably 60 sec or less.

In a case where the retention time exceeds 60 sec, the productivity is lowered.

The heat treatment means in the third heat treatment step has no particular restriction so long as it can conduct the heat treatment at the temperature T₃ and can be selected properly according to the purpose and includes, for example, a thermostat bath, a heating roll, etc.

### (Magnetic Field Alignment)

The method applies a magnetic field at the same time with the alignment step or after the alignment step subsequent to the coating of liquid crystals that form the optical anisotropic layer, which is described in JP-A-2005-316175. The magnetic field is applied preferably in a direction where the difference between a tilt angle in the direction of the magnetic field and an average tilt angle of a liquid crystalline compound at the air boundary side of the liquid crystalline compound layer is less than 10°, preferably, less than 7°, more preferably, less than 5°, and most preferably, less than 3°.

Accordingly, before application of the magnetic field, the average tilt angle of the liquid crystalline compound at the air boundary side of the liquid crystalline compound layer is measured. However, in the production of products, it is preferred to conduct a preliminary experiment to measure the average tilt angle of the liquid crystalline compound (magnetic field can be applied thereby at the same time with the alignment step or just after the alignment step).

The magnetic field intensity is preferably 0.1 tesla or more and more preferably, 1.0 tesla or more.

The temperature in the magnetic field application is identical with the heating temperature in the alignment step (alignment temperature) and it is preferably at a temperature at or higher than the liquid crystal transition temperature of the liquid crystalline compound.

The magnetic field can be applied by using a permanent magnet or an electromagnet.

A plurality of magnets may be used in a bundle and magnetic field may also be applied simultaneously over the entire wide film surface. Further, the magnetic field can be applied also by transporting a film in a region where the magnetic field is generated in a certain direction.

### (Acceleration of Alignment by the Blowing Direction in Drying Step)

By blowing air in a direction inclined from the normal line direction of a film to the air boundary to the liquid crystalline compound in a state of a nematic phase, an alignment control force can be provided to the liquid crystalline molecules at the air boundary side in the direction of blow. This can forcibly make the alignment that fluctuates on the side of the alignment layer uniformly from at the air boundary side. The blowing rate is preferably 3.0 m/s or higher, more preferably, 5.0 m/s or higher and, further preferably, 10.0 m/s or higher.

### (Alignment Acceleration by Low Polymerization Temperature)

Order parameters of the liquid crystalline compound (alignment order) can be increased as the temperature is lower, that is, an alignment state with less fluctuation can be attained. Uniform alignment can be attained by polymerization and fixing at low temperature with less fluctuation. The polymerization temperature is, preferably, 60° C. or lower and, more preferably, 40° C. or lower.

### (Alignment Acceleration by Temperature Difference)

When difference is formed for the temperature, liquid crystals are aligned at a portion where the temperature gradient is present. For example, in a case of roll-to-roll continuous production, alignment can be obtained under conditions, for example, of providing an initial low temperature region and providing a higher temperature region toward the running direction of a film. For more uniform alignment, the temperature gradient is preferably 5° C./cm or more and, more preferably, 10° C./cm or more. However, since crease is caused to the film when the temperature gradient is excessively large, it is preferably 50° C./cm or less.

### (Optical Anisotropic Layer)

An example of the optical compensation sheet of the invention has an optical anisotropic layer formed of a liquid crystal composition containing a liquid crystalline compound on the transparent substrate. The optical anisotropic layer is formed on an alignment layer which is previously formed on the transparent substrate.

Further, a polarizing plate with an optical compensation sheet of the invention can be manufactured also by transferring a liquid crystalline compound layer formed on a separate substrate onto the transparent substrate by using a pressure sensitive adhesive or the like. In this case, the substrate for provisionally supporting the optical anisotropic layer may not always be transparent but it may suffice that the substrate to the transferred is a transparent substrate.

The liquid crystalline compound used for forming the optical anisotropic layer includes rod-like liquid crystalline compounds and discotic liquid crystalline compounds. The rod-like liquid crystalline compounds and the discotic liquid crystalline compounds may be high molecular liquid crystals or low molecular liquid crystals and, further, also include those low molecular liquid crystals which are crosslinked to no more show liquid crystallinity.

### (Rod-Like Liquid Crystalline Compound)

Rod-like liquid crystalline compounds used preferably in the invention include azomethines, azoxys, cyanobiphenyls, cyanophenylates, benzoates, phenylcyclohexane carboxylates, cyanophenyl cyclohexane, cyano substituted phenyl pyrimidines, alkoxy-substituted phenyl pyrimidines, phenyl dioxanes, tolans, and alkenyl cyclohexyl benzonitriles.

The rod-like liquid crystalline compounds also include metal complexes. Further, a liquid crystal polymer containing rod-like liquid crystalline compounds in repetitive units can also be used. That is, the rod-like liquid crystalline compound may be bonded with (liquid crystal) polymer.

The rod-like liquid crystalline compound is described in Kikan Kagaku Sosetsu, vol. 22, “Liquid Crystal Chemistry (1994), edited by the Chemical Society of Japan”, Chapter 4, Chapter 7, and Chapter 11, and Liquid Crystal Device Handbook, edited by Japan Society for the Promotion of Science, 142th committee, Chapter 3.

The birefringence of the rod-like liquid crystalline compound used in the invention is preferably within a range from 0.001 to 0.7.

The rod-like liquid crystalline compound preferably has a polymerizable group for fixing the alignment state. As the polymerizable group, an unsaturated polymerizable group or epoxy group is preferred, and the unsaturated polymerizable group is more preferred, the ethylenically unsaturated polymerizable group is particularly preferred.

### (Discotic Liquid Crystalline Compound)

Discotic liquid crystalline compounds include benzene derivatives described in the Research Report of C. Destrade, et al., Mol. Cryst. vol. 71, p. 111 (1981),—truxene derivatives described in Research Report by C. Destrade, et al., Mol. Cryst. vol. 122, p. 141 (1985), Physics, lett, A, vol. 78, p. 82 (1990), cyclohexane derivatives described in Research Report of B. Kohne, et al., Angew. Chem. vol. 96, p. 70 (1984) and aza crown type or phenyl acetylene type macrocycles described in Research Report of M. Lehn, J. Chem. Commun., p. 1794 (1985), and Research Report of J. Zhang, J. Am. Chem. Soc., vol. 116, p. 2655 (1994).

The discotic liquid crystalline compounds also include compounds showing liquid crystallinity of a structure in which linear alkyl groups, alkoxy groups or substituted benzoyloxy groups are substituted radially as side chains of a scaffold at the center of a molecule. Compounds in which a molecule or an aggregate of molecules have a rotational symmetry and can be provided with a certain alignment are preferred.

In a case of forming an optical anisotroic layer from a discotic liquid crystalline compound, it is no more necessary that the compound contained finally in the optical anisotropic layer shows crystallinity.

Preferred examples of the discotic liquid crystalline compounds are described in JP-A-8-50206. Further, polymerization of discotic liquid crystalline compounds is described in JP-A-8-27284.

Further, in the invention, it is particularly preferred to use the discotic liquid crystalline compound represented by the following general formula (I′).

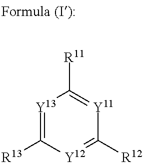

In formula (I′), Y¹¹, Y¹² and Y¹³ each independently represents a methine group or a nitrogen atom. Y¹¹, Y¹² and Y¹³ each is preferably a methane group, more preferably an unsubstituted methine group.

R¹¹, R¹² and R¹³ each independently represent a group of the following formula (I′-A), (I′-B) or (I′-C). When the wavelength dispersibility of the intrinsic birefringence is desired to be lower, the group of formula (I′-A) or (I′-C) is preferred; and the group of formula (I′-A) is more preferred. Preferably, R¹¹, R¹² and R¹³ are the same group.

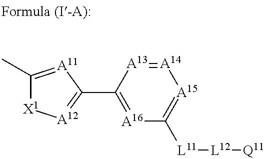

In formula (I′-A), A¹¹, A¹², A¹³, A¹⁴, A¹⁵ and A¹⁶ each independently represent a methine group or a nitrogen atom.

Preferably, at least one of A¹¹ and A¹² is a nitrogen atom; and more preferably, the two are both nitrogen atoms.

Preferably, at least three of A¹³, A¹⁴, A¹⁵ and A¹⁶ are methine groups; and more preferably, they are all methine groups. Preferably, the methine groups are unsubstituted.

Examples of the substituent for the methine group for A¹¹, A¹², A¹³, A¹⁴, A¹⁵ or A¹⁶ include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; and, even more preferred are a halogen atom, an alkyl group having from 1 to 3 carbon atoms, and a trifluoromethyl group.

X¹ represents an oxygen atom, a sulfur atom, a methylene group or an imino group, preferably an oxygen atom.

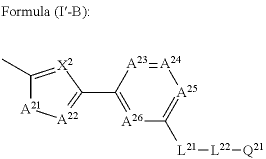

In formula (I′-B), A²¹, A²², A²³, A²⁴, A²⁵ and A²⁶ each independently represent a methine group or a nitrogen atom.

Preferably, at least one of A²¹ and A²² is a nitrogen atom; and more preferably, the two are both nitrogen atoms.

Preferably, at least three of A²³, A²⁴, A²⁵ and A²⁶ are methine groups; and more preferably, they are all methine groups.

When A²¹, A²², A²³, A²⁴, A²⁵ or A²⁶ is a methine group, examples of the substituent for the methine group include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; and even more preferred are a halogen atom, an alkyl group having from 1 to 3 carbon atoms, and a trifluoromethyl group.

X² represents an oxygen atom, a sulfur atom, a methylene group or an imino group, preferably an oxygen atom.

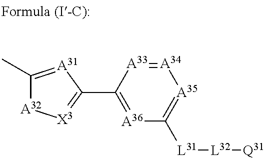

In formula (I′-C), A³¹, A³², A³³, A³⁴, A³⁵ and A³⁶ each independently represent a methine group or a nitrogen atom.

Preferably, at least one of A³¹ and A³² is a nitrogen atom; and more preferably, the two are both nitrogen atoms.

Preferably, at least three of A³³, A³⁴, A³⁵ and A³⁶ are methine groups; and more preferably, they are all methine groups.

When A³¹, A³², A³³, A³⁴, A³⁵ or A³⁶ is a methine group, then the methine group may have a substituent. Examples of the substituent include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; and even more preferred are a halogen atom, an alkyl group having from 1 to 3 carbon atoms, and a trifluoromethyl group.

X³ represents an oxygen atom, a sulfur atom, a methylene group or an imino group, preferably an oxygen atom.

L¹¹ in formula (I′-A), L²¹ in formula (I′-B), and L³¹ in formula (I′-C) each independently represents —O—, —C(—O)—, —O—CO—, —CO—O—, —O—CO—O—, —S—, —NH—, —SO₂—, —CH₂—, —CH—CH—, or —C≡C—; preferably —O—, —C(—O)—, —O—CO—, —CO—O—, —O—CO—O—, —CH₂—, —CH—CH—, or —C≡C—; more preferably —O—, —O—CO—, —CO—O—, —O—CO—O—, or —C≡C—. In particular, L¹¹ in formula (I′-A) is especially preferably —O—, —CO—O— or —C≡C—, as the wavelength dispersibility of the intrinsic birefringence may be expected to be lower; and above all, L¹¹ is even more preferably —CO—O—, as the compound may express a discotic nematic phase at a higher temperature. When the above-mentioned groups contain a hydrogen atom, the hydrogen atom may be substituted with a substituent. Prefer red examples of the substituent are a halogen atom, a cyano group, a nitro group, an alkyl group having from 1 to 6 carbon atoms, a halogen-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl-substituted carbamoyl group having from 2 to 6 carbon atoms, and an acylamino group having from 2 to 6 carbon atoms. More preferred are a halogen atom, and an alkyl group having from 1 to 6 carbon atoms.

L¹² in formula (I′-A), L²² in formula (I′-B), and L³² in formula (I′-C) each independently represents a divalent linking group selected from the group consisting of —O—, —S—, —C(—O)—, —SO₂—, —NH—, —CH₂—, —CH—CH— and —C≡C—, and their combinations. In these, the hydrogen atom of —NH—, —CH₂— and —CH—CH— may be substituted with a substituent. Preferred examples of the substituent are a halogen atom, a cyano group, a nitro group, a hydroxyl group, a carboxyl group, an alkyl group having from 1 to 6 carbon atoms, a halogen-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl-substituted carbamoyl group having from 2 to 6 carbon atoms, and an acylamino group having from 2 to 6 carbon atoms. More preferred are a halogen atom, a hydroxyl group, and an alkyl group having from 1 to 6 carbon atoms; and even more preferred are a halogen atom, a methyl group and an ethyl group.

Preferably, L¹², L²² and L³² are independently selected from the group consisting of —O—, —C(—O)—, —CH₂—, —CH—CH— and —C≡C—, their combinations.

More preferably, L¹², L²² and L³² independently has from 1 to 20 carbon atoms, even more preferably from 2 to 14 carbon atoms. Preferably, they independently have from 1 to 16 (—CH₂—)s, more preferably from 2 to 12 (—CH₂—)s.

The number of the carbon atoms constituting L¹², L²² and L³² has an influence on the phase-transition temperature of the liquid crystal and on the solubility of the compound in solvents. In general, when the number of the carbon atoms is larger, then the temperature for phase transition from the discotic nematic phase (N_{D} phase) to the isotropic liquid phase tends to be lower. On the other hand, the solubility of the compound in solvent tends to be higher when the number of the carbon atoms is larger.

Q¹¹ in formula (I′-A), Q²¹ in formula (I′-B) and Q³¹ in formula (I′-C) each independently represents a polymerizable group or a hydrogen atom. When the compound of the invention is used in an optical film such as an optically-compensatory film, of which the retardation is desired not to change by heat, Q¹¹, Q²¹ and Q³¹ are preferably a polymerizable group. The polymerization reaction is preferably addition polymerization (including ring-cleavage polymerization) or condensation polymerization. Specifically, it is desirable that the polymerizable group is a functional group capable of undergoing addition polymerization or condensation polymerization. Examples of the polymerizable group are mentioned below.

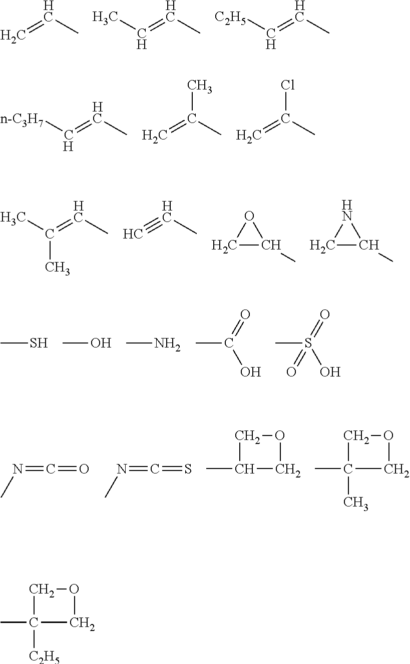

More preferably, the polymerizable group is a functional group capable of undergoing addition polymerization. The polymerizable group of the type is preferably a polymerizable ethylenic unsaturated group or a ring-cleavage polymerizable group.

Examples of the polymerizable ethylenic unsaturated group are the following formulae (M-1) to (M-6):

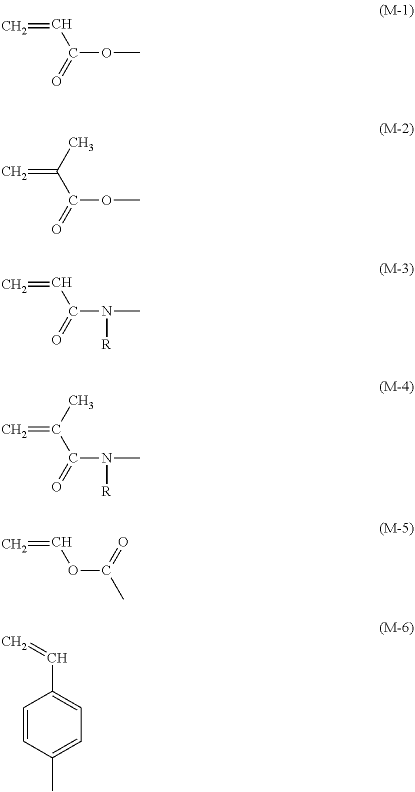

In formulae (M-3) and (M-4), R represents a hydrogen atom or an alkyl group, preferably a hydrogen atom or a methyl group.

Of formulae (M-1) to (M-6), preferred are (M-1) and (M-2); and more preferred is (M-1).

The ring-cleavage polymerizable group is preferably a cyclic ether group, more preferably an epoxy group or an oxetanyl group.

Examples of the compound represented by the formula (I′) includes exemplified compounds described in paragraph (0052) in JP-A-2006-76992 and exemplified compounds described in paragraphs (0040) to (0063) in JP-A-2007-2220, but the invention is not limited to these compounds.

The above compounds can be synthesized by various synthesis methods. For example, the compounds can be synthesized by the method described in paragraphs (0064) to (0070) in JP-A-2007-2220.

It is desirable that the liquid crystalline compound used in the invention develops a liquid crystal phase showing a preferred monodomain property. By making the monodomain property preferable, this can effectively prevent the obtained structure from forming a polydomain thereby causing alignment defects at the boundary between domains to each other and scattering the light. Further, development of the good monodomain property is preferred since the retardation plate has higher light transmittance.

The liquid crystal phase developed by the liquid crystalline compound used in the invention includes a columnar phase, and a discotic nematic phase (ND phase). Among the liquid crystal phases, the discotic nematic phase (ND phase) showing a good monodomain property and capable of hybrid alignment is particularly preferred.

It is more preferred that the liquid crystalline compound used in the invention has smaller anisotropic wavelength dispersibility. Specifically, assuming the phase difference developed by the liquid crystalline compound (in-plane retardation value (nm) of the liquid crystal layer at a wavelength λ (nm)) as Re (λ), Re (450)/Re(650) is preferably less than 1.25, more preferably, 1.20 or less and, particularly preferably, 1.15 or less.

For alignment on the alignment layer disposed on the substrate, it is preferred that an the isotropic transition temperature Tᵢₛₒ of the liquid crystalline compound used in the invention has, preferably, from 100 to 180° C., more preferably, from 100 to 165° C., and, particularly preferably, from 100 to 150° C.

In the hybrid alignment, an angle between the physical axis of symmetry of the liquid crystalline compound of the invention and a plane of an optical anisotropic layer, that is, an angle of inclination increases or decreases along with increase in the depth of the optical anisotropic layer (that is, a distance in the direction perpendicular to the optical anisotropic layer and from the plane of the polarizer).

For the change of the angle of inclination, continuous increase, continuous decrease, intermittent increase, intermittent decrease, change including continuous increase and continuous decrease or intermittent change including increase and decrease is possible. The intermittent change includes a region where the angle of inclination does not change in the course along the direction of the thickness, it may suffice that the angle is increased or decreased as a whole even when a region in which the angle does not change is included. However, the angle of inclination is preferably changed continuously.

Generally, the average direction of the physical axis of symmetry of a discotic liquid crystalline compound can be adjusted by selecting the type of the discotic liquid crystalline compound or the alignment layer. Further, the direction of the physical axis of symmetry of the discotic liquid crystalline compound at the surface side (at the air side) can be controlled generally by selecting the type of the discotic liquid crystalline compound or the additive used together with the discotic liquid crystalline compound.

Examples of the additive used together with the discotic liquid crystalline compound can include, for example, plasticizers, surfactants, polymerizable monomers, polymers and low molecular compounds. The extent for the change of the alignment direction of the major axis can also be controlled in the same manner as described above by the selection of the liquid crystalline compound and the additive.

As the plasticizer and the polymerizable monomer used together with the liquid crystalline compound of the invention, those having a compatibility with the liquid crystalline compound of the invention and capable of providing change to the angle of inclination of the discotic liquid crystalline compound, or those not inhibiting the alignment are adopted.

The surfactant is preferably a fluoro-compound. As the fluoro-surfactant, a compound, for example, showing by the following structural formula can be used.

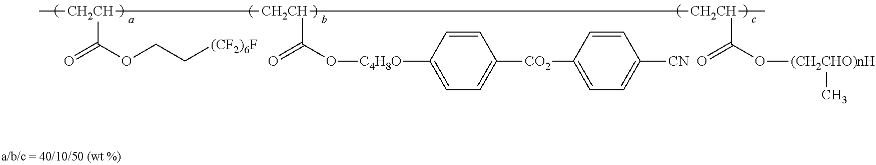

In the invention, the thickness of the optical anisotropic layer is, preferably, from 0.1 to 20 μm, more preferably, from 0.2 to 5 μm, further preferably, from 0.3 to 2 μm and, furthermore preferably, from 0.4 μm to 1 μm.

Since not uniform alignment caused at the boundary of the alignment layer is made uniform by the liquid crystal order as being apart from the alignment layer, the alignment can be made uniform more easily by increasing the film thickness. For controlling the retardation when the film thickness is increased, it is necessary to decrease the refractive index anisotropy of the optical anisotropic layer. For the method, while a method of using a liquid crystalline compound having less refraction index anisotropy, a method of adding non-liquid crystalline compound, or a method of polymerization at a high temperature of lowering the liquid crystal order parameter may be considered, use of a liquid crystalline compound of small refractive index anisotropy is preferred with a view point of suppressing the fluctuation of liquid crystals.

In the invention, while a single kind of a liquid crystalline compound may be used, plural kinds of compounds are used preferably in combination. In the invention, a combination of a discotic liquid crystalline compound and a rod-like liquid crystalline compound is also preferred.

### (Control for Tilt Angle at the Alignment Layer Side)

Generally, in existent alignment control for discotic liquid crystalline compound, the tilt angle of a liquid crystal director at the alignment layer side (between the plane of the alignment layer and the direction of the director of the liquid crystalline compound) is high, and the tilt angle of the liquid crystal director at the air boundary side (between the air boundary and the direction of the director of the liquid crystalline compound) is low. The director of the discotic liquid crystalline compound is vertical to the discotic plane. However, in a case where the tilt angle at the alignment layer side is close to vertical, it is difficult to strengthen the control force for the azimuth angle alignment of the liquid crystalline molecules near the alignment layer. By decreasing the tilt angle at the alignment layer side, the alignment control force in the azimuth angle direction can be strengthened and uniform alignment is possible. The tilt angle at the alignment layer side is preferably, from 40 to 75° and, more preferably, from 50 to 70°. For controlling the tilt angle at the alignment layer side, a known method, for example, of changing the vapor deposition angle of the oblique vapor deposition alignment layer can be used.

(Design for Increasing the Director Angle According to the Distance from the Alignment Layer Side to the Air Boundary Side)

It is preferred to decrease the tilt angle at the alignment layer side for improving the alignment control force for the alignment layer and the liquid crystals. However, in a case where both the tilt angle at the alignment layer side and the tilt angle at the air boundary side are low, since this approaches monoaxial inclined alignment, the (lower) gradation inversion property is worsened. For compatibilizing with the (lower) gradation inversion performance, it is preferred to decrease the tilt angle at the alignment layer side, and increase the tilt angle at the air boundary side. The tilt angle at the alignment layer side is preferably from 0 to 20°. The tilt angle at the air boundary side is, preferably, from 30° to 90° and, more Preferably, 60 to 90°.

For the method of lowering the tilt angle of the liquid crystal director at the alignment layer side, a known method, for example, of changing the vapor deposition angle of an oblique vapor deposition alignment layer can be used. Further, for controlling the tilt angle of the liquid crystal director at the air boundary to about 90°, a method, for example, described in JP-A-2005-128050 can be used.

Further, the tilt angle of the liquid crystal director at the alignment layer side can be lowered by the alignment layer providing high alignment control force. Also, the tilt angle of the liquid crystal director at the alignment layer side can be lowered by using exemplified compounds in paragraphs (0010) to (0016) and (0042) to (0063) in JP-A-2006-11350 and exemplified compounds in paragraphs (0209) to (0238) in JP-A-2006-195140.

### (Polarizing Plate)

The invention also relates to a polarizing plate having at least an optical compensation sheet of the invention and a polarizer.

The polarizer and the optical compensation sheet of the invention can be bonded by utilizing a pressure sensitive adhesive or an adhesive. As the pressure sensitive adhesive or the adhesive, materials of excellent transparency are preferred. Examples of the adhesive include polymer adhesives such as of acrylic type, vinyl alcohol type, silicone type, polyester type, polyurethane type, and polyether type, isocyanate type adhesives, and rubber type adhesives. Examples of the pressure sensitive adhesives include those pressure sensitive adhesives such as of acrylic type, vinyl alcohol type, silicone type, polyester type, polyurethane type, polyether type, isocyanate type, and rubber type.

It is preferred that the adhesive layer interposed between the polarizer and the optical compensation sheet of the invention is thinner and, for example, the thickness is preferably about 10 μm or less and, more preferably, about 5 μm or less.

As the polarizer, a polarizer, for example, obtained by dyeing a polyvinyl alcohol film with iodine and stretching the same is used.

A protective film is preferably bonded also to the other surface of the polarizer and, as such protective film, cellulose acylate film, cyclopolyolefine polymer film, etc. are used.

### (Liquid Crystal Display)

The optical compensation sheet and the polarizing plate of the invention can be used for liquid crystal displays of various display modes such as TN (Twisted Nematic), IPS (In-Plane Switching), FLC (Ferroelectric Liquid Crystal), OCB (Optically Compensatory Bend), STN (Supper Twisted Nematic), VA (Vertically Aligned), and HAN (Hybrid Aligned Nematic).

### (TN Mode Liquid Crystal Device)

The TN mode liquid crystal cell is utilized most frequently as the color TFT liquid crystal display and described in various documents. In the alignment state in the liquid crystal cell at the black display of the TN mode, rod-like liquid crystalline molecules stand up in the central portion of the cell and the rod-like liquid crystalline molecules turn down near the substrate of the cell.

(Relation with the Driving Voltage for Liquid Crystal Cell)

Upon black display, when the driving voltage for the liquid crystal cell is lowered, it turns to direction where the gradation inversion less occurs. In this case, it is necessary to increase the Re value of the optical anisotropic layer as the specification required for the optical compensation sheet in the form of coating the liquid crystalline compound on the transparent substrate as in the invention.

In the existent optical compensation sheet, as the Re value of the optical anisotropic layer is increased, the contrast tends to be lowered in inverse proportion.

When the film of the invention is used, since liquid crystalline molecules contained in the optical anisotropic layer are aligned uniformly, the contrast can be maintained without lowering while keeping the Re value of the optical anisotropic layer to some extent.

### (Measuring Method for Retardation and Tilt Angle of Director)

As described above, in the present invention, Re (λ), and Rth (λ) represent the in-plane retardation and the retardation in the thickness direction respectively, at the wavelength λ. Re(λ) and the tilt angle of the director of the liquid crystalline compound are measured in KOBRA 21ADH or WR (manufactured by Oji Scientic Instruments Co.) by incidence of light at a wavelength (λ) in the direction of the normal line to the film. Upon selection of the measuring wavelength λnm, measurement can be conducted by exchanging a wavelength selection filter manually or converting measured values by a program or the like.

In a case where the film to be measured is represented by a uniaxial or biaxial refractive index ellipsoid, Rth (λ) is calculated by the following method.

Rth(λ) is calculated in KOBRA 21 ADH or WR by measuring the Re(λ) at 6 points in total by the incidence of a light of a wavelength of Xnm with the retardation axis in the plane (judged by KOBRA 21ADH or WR) being as an axis of inclination (axis of rotation) in a case where the retardation axis it not present, an optional direction in the plane of the film is assumed as the axis of rotation), at each of 10° steps up to 50° relative to the direction of the normal line of the film on one side of the normal direction in each direction of inclination, based on the measured retardation value, the assumed value for the average refraction index, and the inputted value for film thickness.

In the measurement described above, in a case of a film having a direction where the value of the retardation becomes 0 at a certain angle of inclination from the normal direction with the retardation axis in the plane being as a rotational angle, a retardation value at a larger angle of inclination than the certain angle of inclination is calculated by KOBRA 21 ADH or WR after inverting the sign to the negative polarity.

Rth can be calculated also by the following Equation (I) and (II) with the retardation axis as an axis of inclination (axis of rotation) (in a case where the axis of retardation is not present, an optional direction in the film plane is defined as an axis of rotation) by measuring the retardation value from two optional inclined directions, and based on the measured value, the assumed value for the average refractive index, and the inputted value for film thickness.

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Equation ( I ) \\ Rth = \{ ( nx + ny ) / 2 - nz \} \times d & Equation ( II )\end{matrix}$$

In the formulae, Re(θ) represents a retardation value in the direction inclined by an angle θ from the direction of the normal line.

Further, nx represents a refractive index in the direction of the retardation axis in the plane. ny represents a refractive index in the direction perpendicular to nx in the plane, nz represents a refractive index in the direction perpendicular to nx and ny, and d represents a film thickness.

Rth (λ) is calculated by the following method in a case of a film where the film to be measured cannot be expressed by a uniaxial or biaxial refractive index ellipsoid, that is, a film so-called with no optical axis.

Rth (λ) is calculated in KOBRA 21 ADH or WR by measuring Re (λ) at 11 points by the incidence of a light of a wavelength of λnm with the retardation axis in the plane (judged by KOBRA 21 ADH or WR) being as an axis of inclination (axis of rotation) at each of 10° steps from −50° to +50° relative to the direction of the normal line of the film in each direction of inclination, based on the measured retardation value, the assumed value for the average refractive index, and the inputted value for film thickness.

In the measurement described above, for the assumed value of the average refractive index, values in the Polymer Handbook (JOHN WILEY & SONS, INC), and values in Various catalogues for optical compensation sheets can be used.

Further, those in which the value for the average refractive index is not known can be measured by an Abbe refractometer. Values for average refractive indexes for main optical compensation sheets are exemplified below.

Cellulose acylate (1.48), cycloolefin polymer (1.52), polycarbonate (1.59), polymethyl methacrylate (1.49), and polystyrene (1.59).

By inputting the assumed value for the average refractive index and the film thickness, nx, ny, nz are calculated by KOBRA 21ADH or WR. Nz=(nx−nz)/(nx−ny) is further calculated based on the calculated nx, ny, and nz.

### (Measuring Method for the Distribution of Alignment Axes)

An optical compensation sheet having a liquid crystal layer is photographed by a digital camera by using a polarization microscope in which polarizing plates are put in the cross Nichol configuration at a magnification factor of 400×, while rotating the stage at an angle each by 0.5 degree and within a range of ±10 degree with the angle for the most darkened stage as the center. Then, by conducting rotation and parallel moving treatment for the image photographed by the digital camera, the position of the image is aligned accurately on the basis of the pixel unit. Then, the angle where the image is most darkened is recorded on every pixel, and a histogram formed by plotting the angle on the abscissa and the number of most darkened pixels at the angle on the ordinate to determine a half width value thereof.

As the polarization microscope, a known microscope can be used and, for example, ECLIPSE E600POL manufactured by Nikon Corp. can be used. Further, the rotational and parallel moving treatment for the image described above can be conducted by using a commercial program.

“Minute region” defined in the present specification is a narrow region surrounded at μm order and, specifically, a region of about 0.1 μm to 500 μm square. This is a region that can be measured at the magnification factor of 400× by the polarization microscope as described above and can be measured by using a measuring instrument of high resolution (for example, “LCA-LU4A” manufactured by MEIRYO TECHNICA CORP.).

### (Measuring Method for Film Contrast Value)

On a table, a fluorescent tube direct backlight light source, a polarizing plate, a specimen, and another polarizing plate are arranged orderly from below such that each of the surfaces thereof is horizontal. In this case, the specimen and the upper polarizing plate are made rotatable. A light emitted from the light source and transmitting the polarizing plate, the specimen, and the polarizing plate successively was measured for the luminance in the vertical direction by using BM-5A (manufactured by TOPCON CORP.). Upon measurement, the upper polarizing plate is at first rotated in a state with no specimen and aligned to a position where the luminance is darkest (cross Nichol configuration). Then, the specimen is inserted and the specimen is rotated under the cross Nichol configuration to measure the minimum luminance. Then, the polarizing plates are put in a parallel Nichol configuration and the specimen is rotated to measure the maximum luminance. The film contrast was determined by (maximum luminance under the parallel Nichol configuration/(minimum luminance under the cross Nichol configuration).

### (Evaluation Method for the Film Plane Shape)

Polarizing plates were arranged under a cross Nichol configuration on a schaukasten and a specimen was arranged therebetween at a position where it was viewed darkest as observed from the front. It was judged as below depending on the view of unevenness when observed from an oblique direction.

A: unevenness is not observed at all
B: unevenness is observed weakly
C: unevenness is observed intensely

### (Evaluation Method for Display Performance)

Then, a liquid crystal display left in a room controlled to 25° C., 60% RH for one week was measured for the luminance in the black display (L0) and the white display (L7) by using a measuring instrument (BM-5A, manufactured by TOPCON CORP.) to calculate the frontal contrast (L7/L0). Further, in each of gradations of L1 where the frontal luminance was 1/7 and L2 where it was 2/7 for L7, the angle where the luminance was inverted in the lower direction was measured as a lower gradation inversion angle.

Further, as tint evaluation for the view angle, the distance on the u′ v′ space when the view angle was tilted by 60° from the front was calculated as ΔCu′v′. (u′ v′: color coordinate in CIELAB space)

ΔCu′v′=(u′(front)−u′(60°))²+(v′(front)−v′(60°))²)^{0.5}.

For the maximum amount of ΔCu′v′ in all azimuth angles, it was evaluated as

A: ΔCu′v′ is less than 0.04
B: ΔCu′v′ is from 0.04 to 0.10
C: ΔCu′v′ is from 0.10 to 0.20
D: ΔCu′v′ exceeds 0.20

Further, as the contrast evaluation for the view angle, total for the contrast values in upper and lower and right and left at the view angle of 80° was calculated and evaluated as described below.

A: total of the contrast value for the view angle in Upper/Lower Right/Left is 100 or more
B: total of the contrast value for the view angle in Upper/Lower Right/Left is 50 to 100.
C: total of the contrast value for the view angle in Upper/Lower Right/Left is 30 to 50.

### EXAMPLES

### Example 1

### Manufacture of Optical Compensation Sheet

### (Manufacture of Substrate (S-1))

The following composition was charged in a mixing tank and stirred while heating at 30° C. to dissolve each of the ingredients to prepare a cellulose acetate solution.

TABLE 1

| | Inner | Outer |
|---|---|---|
| Cellulose acetate solution composition (mass parts) | layer | layer |
| Cellulose acetate at 60.9% acetylation degree | 100 | 100 |
| Triphenyl phosphate (plasticizer) | 7.8 | 7.8 |
| Biphenyl diphenyl phosphate (plasticizer) | 3.9 | 3.9 |
| Methylene chloride (first solvent) | 293 | 314 |
| Methanol (second solvent) | 71 | 76 |
| 1-butanol (third solvent) | 1.5 | 1.5 |
| Silica fine particles (AEROSIL R972, manufactured | 0 | 0.8 |
| by Nippon Aerosil Co.) | | |
| Retardation improver described below | 1.7 | 0 |

Retardation improver

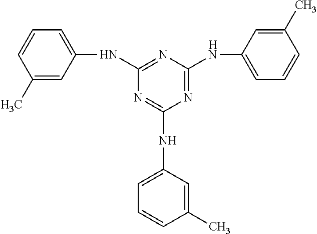

The dopes for the inner layers and the dope for the outer layer obtained were cast on a drum cooled to 0° C. by using a three layer cocasting die. A film with an amount of residual solvent of 70 mass % was stripped from the drum, and dried at 80° C. during transportation while fixing both ends by a pin tenter at a draw ratio of 110% in the transportation direction and dried at 110° C. when the amount of the residual solvent was decreased to 10%. Then, the film was dried at a temperature of 140° C. for 30 min to produce a cellulose acetate film with 0.3 mass % of the residual solvent (outer layer: 3 μm, inner layer: 74 μm, outer layer: 3 μm). The thus manufactured cellulose acetate film S-1 was measured for optical properties.

The obtained cellulose acetate film had 1340 mm width and 80 μm thickness. Re was 6 nm and Rth was 90 nm.

### (Manufacture of Alignment Layer)

An oblique SiO deposition film with an angle of inclination of 20° and a film thickness of about 400 angstrom was formed on the prepared substrate S-1.

### (Coating of Optical Anisotropic Layer)

The following composition was dissolved in 270 kg of methylethyl ketone to prepare a coating solution.

(Composition for Forming Optical Anisotropic Layer)

| | |
|---|---|
| Liquid crystalline compound (1) shown below | 90.0 mass parts |
| Liquid crystalline compound (2) shown below | 10.0 mass parts |
| Fluoro-aliphatic group containing polymer-1 | 0.8 mass parts |
| shown below | |
| Photopolymerization unitiator | 3.0 mass parts |
| (IRGACURE 907, manufactured by Ciba Guigy) | |
| Sensitizer (KAYACURE DETX, | 1.0 mass parts |
| manufactured by NIPPON KAYAKU CO. LTD.) | |

(Liquid crystalline compound 1) 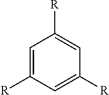 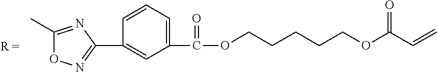
(Liquid crystalline compound 2) 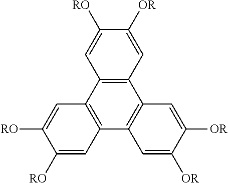 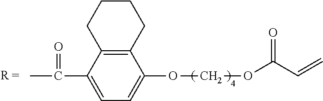
Fluoro-aliphatic group containing polymer-1

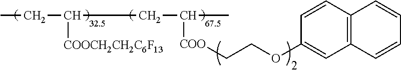

The prepared coating solution was coated on the surface of the alignment layer by using a #2.8 wire bar. The coating amount was 4.8 mL/m². Then, it was heated in a thermostat bath at 120° C. for 300 sec to align the discotic liquid crystalline compound. Then, crosslinking reaction was proceeded by irradiation of UV-light at 80° C. for 1 min by using a 160 W/cm high pressure mercury lamp to polymerize the discotic liquid crystalline compound and, form an optical anisotropic layer, thereby manufacturing an optical compensation sheet C-1. The optical anisotropic layer had a film thickness of 0.8 μm and a retardation (550 nm) of 45 nm. Further, the liquid crystal director angle on the side of the alignment layer was 20°, and the liquid crystal director angle on the side of the air boundary was 75°.

### (Manufacture of Polarizing Plate)

A linear polarized film was manufactured by adsorbing iodine to a stretched polyvinyl alcohol film. Then, a triacetyl cellulose film (TAC-TD80U, manufactured by Fuji Film Corp.) was saponified and bonded on one side of the linear polarizer by using a vinyl alcohol type adhesive. Further, the manufactured optical compensation sheet C-1 was bonded to the other surface of the linear polarizer by using a polyvinyl alcohol type adhesive such that the rear face of the substrate S-1 (surface on the side not formed with the optical anisotropic layer) is on the side of the surface of the linear polarizer to manufacture a polarizing plate (P-1). In this case, the transportation direction of the substrate S-1 was made parallel with the absorption axis of a polarizer.

### (Manufacture of TN Mode Liquid Crystal Display)

A pair of polarizing plates (upper polarizing plate and lower polarizing plate) disposed to a liquid crystal display using a TN type liquid crystal cell (AL2216W, manufactured by Acer Inc.) were peeled and, instead, the manufactured polarizing plate P-1 was bonded by way of a pressure sensitive adhesive to both surfaces of a liquid crystal cell such that the manufactured optical compensation sheet C-1 was on the side of the cell, such that the adsorption axis of the polarizer is identical with that of the original liquid crystal display.

### Comparative Example 1

### Manufacture of Alignment Layer

A saponification treatment was applied on the substrate S-1 prepared in Example 1 and the alignment layer coating solution of the following composition was coated at 28 mL/m² by a #16 wire bar coater. It was dried by a warm blow at 60° C. for 60 sec and further by a warm blow at 90° C. for 150 sec to manufacture an alignment layer. The thickness of the alignment layer after drying was 1.1 μm.

TABLE 2
(Composition for alignment layer coating solution)

| Ingredient | |
|---|---|
| Modified polyvinyl alcohol shown by the | 10 mass parts |
| following structural formula (*) | |
| Water | 371 mass parts |
| Methanol | 119 mass parts |
| Glutar aldehyde (crosslinking agent) | 0.5 mass parts |
| Citric acid ester (AS-3, manufactured by Sankyo | 0.35 mass parts |
| Chemical Co.) | |

(Modified polyvinyl alcohol*)

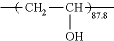

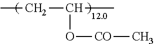

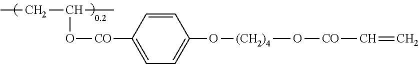

### (Aligning Treatment)

A rubbing treatment was applied to the surface of the alignment layer on the substrate S-1 such that the alignment layer was aligned in parallel to a transportation direction. A rubbing roll was rotated at 450 rpm.

### (Coating of Optical Anisotropic Layer)

An optical anisotropic layer was prepared in the same manner as in Example 1, and a TN mode liquid crystal display applying the thus prepared polarizing plate was manufactured.

The optical anisotropic layer had a film thickness of 0.8 μm and retardation (550 nm) of 43 nm. Further, the liquid crystal director angle was 85° at the alignment layer side and the liquid crystal director angle was 15° at the air boundary side.

### Example 2

The following optical alignment compound was coated as a 1 wt % solution in cyclohexanone on the substrate S-1 prepared in Example 1 to form an optical alignment layer of 100 nm. A non-polarized UV-light was irradiated for 5 min in a direction inclined by 45° C. from the normal line direction to the thus formed optical alignment layer by using a 160 W/cm high pressure mercury lamp. Then, an optical anisotropic layer was coated in the same manner as in Example 1 to prepare an optical compensation sheet thereby manufacturing a polarizing plate.

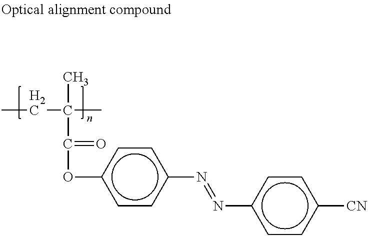

### Example 3

An optical compensation sheet and a polarizing plate were manufactured in the same manner as in Comparative Example 1 except for manufacturing the optical anisotropic layer in Example 1 as described below.

### (Manufacture of Optical Anisotropic Layer)

### (Coating Solution Composition of Optical Anisotropic Layer)

The following composition was dissolved in 97 mass parts of methyl ethyl ketone to prepare a coating solution.

| | |
|---|---|
| Discotic liquid crystalline compound described below | 41.01 mass parts |
| Ethylene oxide modified trimethylol propane triacrylate | 4.06 mass parts |
| (V#360, Osaka Organic Chemical Industry Ltd.) | |
| Fluoro-aliphatic group containing polymer-1 | 0.56 mass parts |
| described below | |
| Photo polymerization initiator | 1.35 mass parts |
| (IRGACURE 907 manufacturedby Ciba Geigy Co.) | |
| Sensitizer (KAYACURE-DETX, manufactured by | 0.45 mass parts |
| Nippon Kayaku Co., Ltd.) | |

Discotic liquid crystalline compound 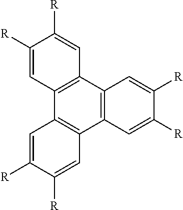 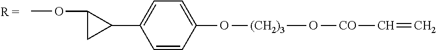
Fluoro-aliphatic group containing polymer-1 (a/b = 90/10 wt %)

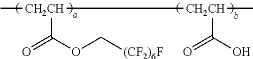

The prepared coating solution was coated on the surface of the alignment layer by using a #5.0 wire bar. The coating amount was 8.6 mL/m². Then, it was heated in a thermostat bath at 130° C. for 300 sec to align the discotic liquid crystalline compound. Then, a UV-light was irradiated at 80° C. for one min using a 160 W/cm high pressure mercury lamp to proceed crosslinking reaction and polymerize the discotic liquid crystalline compound to form an optical anisotropic layer thereby manufacturing an optical compensation sheet C-1. The optical anisotropic layer had a film thickness of 2.5 μm and a retardation (550 nm) of 45 nm.

### Example 4

An optical compensation sheet and a polarizing plate were manufactured in the same manner as in Comparative Example 1 except for blowing a uniform blow at 12.0 m/s to the coating film surface in the direction along the rubbing direction during heating at 120° C. in Comparative Example 1.

### Example 5

In Comparative Example 1, magnetic fields were applied in a direction inclined by 40° in the direction identical with the direction of inclination of a discotic surface of the liquid crystalline compound during drying at 120° C. and irradiation of a UV-light at 80° C. The intensity of the magnetic fields was controlled to 0.7 tesla. An optical compensation sheet and a polarizing plate were manufactured in the same manner as in Comparative Example 1 except for the procedures described above.

### Example 6

In Comparative Example 1, after coating the optical anisotropic layer, it was heated in a thermostat bath at 140° C. for 200 sec and then heated in a thermostat bath at 120° C. for 100 sec to align the discotic liquid crystalline compound. In this case, the discotic liquid crystal showed an isotropic phase in a thermostat bath at 140° C. and showed a nematic phase in a thermostat bath at 120° C. An optical compensation sheet and a polarizing plate were manufactured in the same manner as in Comparative Example 1 except for the procedures described above.

### Example 7

A coating solution was prepared by dissolving 41.01 g of the following discotic liquid crystalline compound, 4.06 g of ethylene oxide modified trimethylol propane acrylate (V#360, manufactured by Osaka Organic Chemical Industry Ltd.), 1.85 g of the following 1,3,5-triazine compound, 1.35 g of a photopolymerization initiator (IRGACURE 907, manufactured by Ciba Geigy Co.), and 0.45 g of a sensitizer (KAYACURE-DETX, manufactured by Nippon Kayaku Co., Ltd.) in 95 g of methyl ethyl ketone to prepare a coating solution.

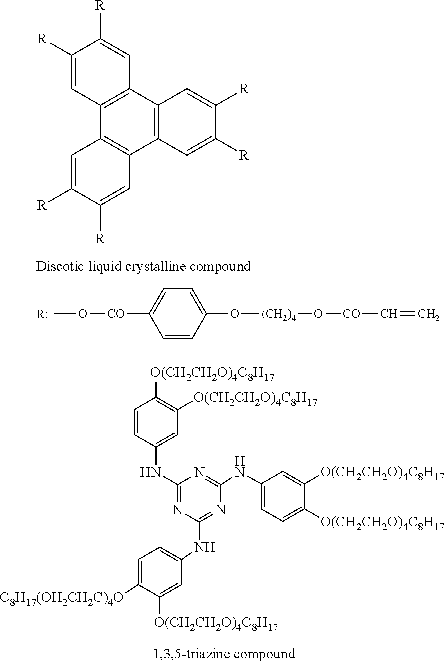

In Comparative Example 1, after the alignment treatment to the alignment layer, the coating solution was coated on the alignment layer by a #4 wire bar. This was bonded to a metal frame and heated in a thermostat bath at 120° C. for 30 sec to align the discotic liquid crystalline compound. When a UV-light at 2J was irradiated by using a high pressure mercury lamp in a state at 120° C. to polymerize the discotic liquid crystalline compound and the state of alignment was confirmed, the liquid crystalline compound was aligned horizontally.

Then, after heating in a thermostat bath at 120° C. for 30 sec as described above, temperature was changed to 80° C., a UV-light at 2J was irradiated by using a high pressure mercury lamp to polymerize the discotic liquid crystalline compound. Then, it was allowed to cool to a room temperature. As described above, the optical anisotropic layer was formed to manufacture an optical compensation sheet. The liquid crystalline compound was hybrid-aligned and Re of the optical anisotropic layer was 43 nm.

### Example 8

In Comparative Example 1, after coating the optical anisotropic layer and heating in a thermostat bath at 120° C. for 300 sec, a film was passed over a roll at 120° C. and a roll at 80° C. arranged at a distance of 2 cm. Immediately thereafter, a UV-light was irradiated at 80° C. for one min by using a 160 W/cm high pressure mercury lamp to proceed crosslinking reaction and polymerize the discotic liquid crystalline compound thereby forming an optical anisotropic layer. An optical compensation sheet and a polarizing plate were manufactured in the same manner as in Comparative Example 1 except for the procedures described above.

### Example 9

An optical compensation sheet and a polarizing plate were manufactured in the same manner as in Comparative Example 1 except for the procedures of irradiating a UV-light at 30° C. for one min by using a 160 W/cm high pressure mercury lamp after the coating and heating treatment for the optical anisotropic layer to proceed the crosslinking reaction and polymerize discotic crystalline compound in Comparative Example 1.

### Example 10

After coating the optical anisotropic layer in Example 2, magnetic fields were applied in a direction inclined by 40° in the direction identical with the direction of inclination of the discotic surface of the liquid crystalline compound during drying at 120° C. and irradiation of a UV-light at 80° C. The intensity of the magnetic fields was controlled to 0.7 tesla. An optical compensation sheet and a polarizing plate were manufactured in the same manner as in Example 1 except for the procedures described above.

### Example 11

An optical compensation sheet and a polarizing plate were manufactured in the same manner as in Example 1 except for applying identical magnetic fields with those in Example 5 after coating the optical anisotropic layer in Example 2.

### Example 12

An optical compensation sheet and a polarizing plate were manufactured in the same manner as in Example 1 except for applying the same heat treatment as in Example 6 after coating the optical anisotropic layer in Example 2.

### Example 13

An optical compensation sheet and a polarizing plate were manufactured in the same manner as in Example 1 except for applying the same horizontal alignment treatment as in Example 7 after coating the optical anisotropic layer in Example 2.

### Example 14

After coating the optical anisotropic layer in Example 2, an optical anisotropic layer was formed in the same manner as in Example 8. An optical compensation sheet and a polarizing plate were manufactured in the same manner as in Example 1 except for the procedures described above.

### Example 15

After coating the optical anisotropic layer in Example 2, an optical anisotropic layer was formed in the same manner as in Example 9. An optical compensation sheet and a polarizing plate were manufactured in the same manner as in Example 1 except for procedures described above.

### Example 16

An optical compensation sheet and a polarizing plate were manufactured in the same manner as in Example 1 except for changing the oblique vapor deposition angle of the inorganic alignment layer in Example 1 to 45°.

The liquid crystal director angle at the alignment layer side was 45° and the liquid crystal director angle at the air boundary side was 75° C. in the optical anisotropic layer.

### Example 17

An alignment layer was manufactured while changing the oblique vapor deposition angle of the inorganic alignment layer in Example 1 to 85°.

As an optical anisotropic coating solution, a coating solution was prepared by dissolving 41.01 g of the following discotic liquid crystalline compound, 4.06 g of ethylene oxide modified trimethylol propane acrylate (V#360, manufactured by Osaka Organic Chemical Industry Ltd.), 1.00 g of the following alignment controller, 1.35 g of a photopolymerization initiator (IRGACURE 907, manufactured by Ciba Geigy Co.), and 0.45 g of a sensitizer (KAYACURE-DETX, manufactured by Nippon Kayaku Co., Ltd.) in 95 g of methyl ethyl ketone.

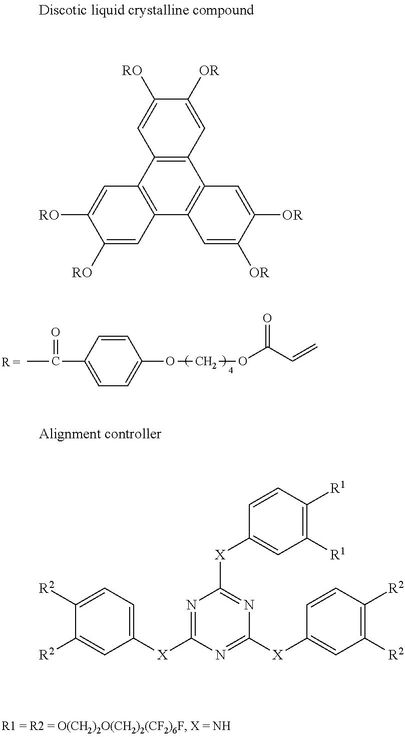

The prepared coating solution was coated on the surface of the alignment layer by using a #3.2 wire bar. Then, it was heated in a thermostat bath at 130° C. for 300 sec to align the discotic liquid crystalline compound. Then, a UV-light was irradiated at 80° C. for one min by using a 160 W/cm high pressure mercury lamp to proceed crosslinking reaction and polymerize the discotic liquid crystalline compound to form an optical anisotropic layer thereby manufacturing an optical compensation sheet. The film thickness of the optical anisotropic layer was 1.4 μm. The retardation (550 nm) was 45 nm, the liquid crystal director angle at the alignment layer side was 85° and the liquid crystal director angle at the air boundary side was 0°.

### Example 18

### Design of Utilizing Increase of Front CR for the Improvement of Grey-Scale Inversion by Combination with a Panel Controlled for Black Voltage

An optical compensation sheet and a polarizing plate were manufactured in the same manner as in Example 1 except for applying the rubbing treatment while displacing the rubbing direction by 4° from the transportation direction of the substrate S-1 and coating the optical anisotropic layer by a #2.8 wire bar in Example 1. The polarizing plate was bonded to a liquid crystal display in the same manner as in Example 1 such that the black display (L0) was set to a gradation where the luminance is lowest.

### Example 19

### Manufacture of Alignment layer

A saponification treatment was applied on the substrate S-1 prepared in Example 1 and the alignment layer coating solution of the following composition was coated at 24 mL/m² by a #14 wire bar coater. It was dried by a warm blow at 100° C. for 120 sec to manufacture an alignment layer. The thickness of the alignment layer after drying was 1.2 μm. Next, a rubbing treatment was applied to the surface of the alignment layer such that it was aligned in parallel to a transportation direction. A rubbing roll was rotated at 400 rpm.

(Composition for alignment layer coating solution)

| | |
|---|---|
| Polymer for alignment layer set forth below | 40 mass parts |
| Water | 700 mass parts |
| Methanol | 300 mass parts |
| Triethylamine | 20 mass parts |

(Polymer for alignment layer) 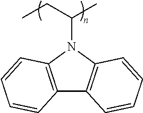 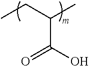 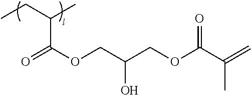
n = 40, m = 50, l = 10

### (Coating of Optical Anisotropic Layer)

The coating solution of the following composition was coated on the rubbing-treated surface of the alignment layer by using a #2.8 wire bar. Then, it was heated in a thermostat bath at 130° C. for 120 sec to align the discotic liquid crystalline compound. Next, a UV-light was irradiated at 80° C. for one min using a 160 W/cm high pressure mercury lamp to proceed crosslinking reaction and polymerize the discotic liquid crystalline compound to form an optical anisotropic layer. After that, it was left uncontrolled to be cooled to a room temperature thereby manufacturing an optical compensation layer.

(Composition for Forming Optical Anisotropic Layer)

| | |
|---|---|
| Methylethyl ketone | 270 mass pats |
| Discotic liquid crystalline compound A1 below | 100 mass parts |
| Air side alignment controller B1 below | 1.0 mass part |
| Photo polymerization initiator (IRGACURE 907 manufactured by Ciba Geigy Co.) | 3.0 mass parts |
| Sensitizer (KAYACURE-DETX, manufactured by Nippon Kayaku Co., Ltd.) | 1.0 mass parts |

(A1) 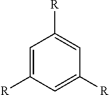 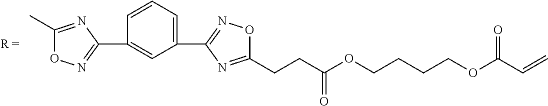
(B1)

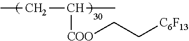

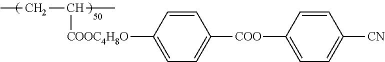

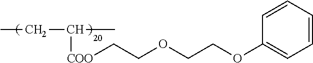

The thus-obtained optical anisotropic layer had a film thickness of 0.8 μm and a retardation (550 nm) of 44 nm. The liquid crystal director angle at the alignment layer side was 15° and the liquid crystal director angle at the air boundary side was 70°.

The result for the evaluation of the performance of the polarizing plate and the liquid crystal display in Examples 1 to 18 and Comparative Example 1 is shown in the following table. The production cost (production yield (estimated)) was evaluated according to the following criteria.

A: yield at 90% or more
B: yield at 80 to 90%
C: yield at 60 to 80%

TABLE 3

| | | Manufacturing method | Alignment axis of | Film | | Production | Film | View | View | Grey-scale |
|---|---|---|---|---|---|---|---|---|---|---|
| | Formulation for | for alignment | distribution | contrast | front | cost | surface | angle | angle | inversion |
| | Alignment | layer | Half-width value | value | contrast | (yield) | state | tint | CR | angle |
| Comp. | Existent formulation | Existent method | 3.2° | 3000 | 900 | C | A | B | B | 35° |
| Example 1 | | | | | | | | | | |
| Example 1 | Inorganic alignment | Existent method | 2.0° | 5000 | 1200 | B | A | B | B | 35° |
| | layer | | | | | | | | | |
| Example 2 | Optical alignment | Existent method | 1.5° | 8000 | 1400 | B | A | B | B | 35° |
| Example 3 | Film thickness | Existent method | 2.0° | 5000 | 1200 | C | A | C | A | 35° |
| | increased | | | | | | | | | |
| Example 4 | Existent formulation | Blowing alignment | 2.0° | 5000 | 1200 | C | A | B | B | 35° |
| Example 5 | Existent formulation | Magnetic field | 2.5° | 4200 | 1050 | C | A | B | B | 35° |
| | | alignment | | | | | | | | |
| Example 6 | Existent formulation | Via iso phase | 2.5° | 4200 | 1050 | C | A | B | B | 35° |
| Example 7 | Existent formulation | Horizontal alignment | 2.0° | 5000 | 1200 | B | B | B | B | 35° |
| | | for disk surface | | | | | | | | |
| Example 8 | Existent formulation | Temperature | 2.5° | 4200 | 1050 | C | A | B | B | 35° |
| | | difference | | | | | | | | |
| | | alignment | | | | | | | | |
| Example 9 | Existent formulation | Polymerization | 2.5° | 4200 | 1050 | C | A | B | B | 35° |
| | | temperature reduced | | | | | | | | |
| Example 10 | Optical alignment | Blowing alignment | 1.0° | 10000 | 1500 | B | A | B | B | 35° |
| Example 11 | Optical alignment | Magnetic field | 1.5° | 8000 | 1400 | B | A | B | B | 35° |
| | | alignment | | | | | | | | |
| Example 12 | Optical alignment | Via iso phase via | 1.5° | 8000 | 1400 | B | A | B | B | 35° |
| Example 13 | Optical alignment | Horizontal alignment | 1.0° | 10000 | 1500 | A | B | B | B | 35° |
| | | for disk surface | | | | | | | | |
| Example 14 | Optical alignment | Temperature | 1.5° | 8000 | 1400 | B | A | B | B | 35° |
| | | difference alignment | | | | | | | | |
| Example 15 | Optical alignment | Polymerization | 1.5° | 8000 | 1400 | B | A | B | B | 35° |
| | | temperature: 30° C. | | | | | | | | |
| Example 16 | Tilt angle changed | Existent method | 1.0° | 10000 | 1500 | B | A | C | A | 30° |
| Example 17 | Tile angle changed | Blowing alignment | 1.0° | 10000 | 1500 | B | B | A | C | 35° |
| Example 18 | Optical alignment | Blowing alignment | 1.0° | 10000 | 1400 | B | A | B | B | 45° |
| Example 19 | Alignment layer | Existent method | 1.0° | 10000 | 1500 | B | A | A | B | 35° |
| | providing high alignment | | | | | | | | | |
| | control force | | | | | | | | | |

What is claimed is:

1. An optical compensation sheet comprising: a transparent substrate; and at least one optical anisotropic layer containing a liquid crystalline compound, wherein the optical compensation sheet has a film contrast value of 4000 or more, the film contrast value being represented by formula (1).
film contrast value=(maximum luminance of the optical compensation sheet disposed between polarizing plates arranged in a parallel Nichol configuration)/(minimum luminance of the optical compensation sheet disposed between the polarizing plates arranged in a cross Nichol configuration) Formula (1)

2. The optical compensation sheet according to claim 1, wherein a half-width value of an alignment axis distribution of the liquid crystalline compound in a minute region is 3.0° or less.

3. The optical compensation sheet according to claim 1, wherein the liquid crystalline compound is hybrid-aligned.

4. The optical compensation sheet according to claim 1, wherein the liquid crystalline compound is a discotic liquid crystal.

5. The optical compensation sheet according to claim 1, wherein a director tilt angle of the liquid crystalline compound at a transparent substrate side of the optical anisotropic layer is 40° to 75°.

6. The optical compensation sheet according to claim 1, wherein a director tilt angle of the liquid crystalline compound at a transparent substrate side of the optical anisotropic layer is 0° to 20° and a director tilt angle of the liquid crystalline compound at an air boundary side of the optical anisotropic layer is 30° to 90°.

7. The optical compensation sheet according to claim 1, further comprising an optical alignment layer between the transparent substrate and the optical anisotropic layer, wherein the liquid crystalline compound is aligned by an alignment control force provided by the optical alignment layer.

8. The optical compensation sheet according to claim 1, further comprising an inorganic alignment layer between the transparent substrate and the optical anisotropic layer, formed by oblique vapor deposition, wherein the liquid crystalline compound is aligned by an alignment control force provided by the inorganic alignment layer.

9. The optical compensation sheet according to claim 1, wherein the optical anisotropic layer has a thickness of 2.0 μm or more.

10. A method of manufacturing an optical compensation sheet according to claim 1, comprising:
coating a composition containing a liquid crystalline compound on a substrate having an alignment layer,
keeping the coated composition at a temperature of the liquid crystalline compound forming a liquid crystal phase to align the liquid crystalline compound in an aligned state to form a pre-layer of the optical anisotropic layer;
providing an alignment control force by eternal force on an air boundary side of the pre-layer; and
fixing the liquid crystalline compound in the aligned state to form optical anisotropic layer.

11. The method according to claim 10, wherein the providing of the alignment control force includes applying a uniform blow at a uniform rate of 3.0 m/s in a direction.

12. A method of manufacturing an optical compensation sheet according to claim 1, comprising:
coating a composition containing a liquid crystalline compound on a substrate having an alignment layer,
keeping the coated composition at a temperature of the liquid crystalline compound forming a liquid crystal phase to align the liquid crystalline compound in an aligned state to form a pre-layer of the optical anisotropic layer;
applying a magnetic field to the pre-layer; and
fixing the liquid crystalline compound in the aligned state to form optical anisotropic layer.

13. A method of manufacturing an optical compensation sheet according to claim 1, comprising:
coating a composition containing a liquid crystalline compound on a substrate having an alignment layer,
keeping the coated composition at a temperature of the liquid crystalline compound forming a liquid crystal phase to align the liquid crystalline compound in an aligned state to form a pre-layer of the optical anisotropic layer;
causing a temperature difference of 10° C./m or more relative to a transportation direction of the substrate; and
fixing the liquid crystalline compound in the aligned state to form optical anisotropic layer.

14. A method of manufacturing an optical compensation sheet according to claim 1, comprising:
coating a composition containing a liquid crystalline compound on a substrate having an alignment layer,
keeping the coated composition at a temperature of the liquid crystalline compound forming a liquid crystal phase to align the liquid crystalline compound in an aligned state to form a pre-layer of the optical anisotropic layer; and
fixing the liquid crystalline compound in the aligned state to form optical anisotropic layer,
wherein the temperature in the keeping of the coated composition to align the liquid crystalline compound in the aligned state is 40° C. or lower.

15. A method of manufacturing an optical compensation sheet according to claim 1, comprising:
coating a composition containing a liquid crystalline compound on a substrate having an alignment layer,
keeping the coated composition at a temperature of the liquid crystalline compound forming a liquid crystal phase to align the liquid crystalline compound in an aligned state to form a pre-layer of the optical anisotropic layer; and
fixing the liquid crystalline compound in the aligned state to form optical anisotropic layer,
wherein the keeping of the coated composition to align the liquid crystalline compound in the aligned state includes: keeping the coated composition for at least 20 sec at T₁ which is a temperature at or higher than a nematic-isotropic phase transition temperature Tᵢₛₒ of the composition; and applying to the coated composition a heat treatment at T₂ lower than Tᵢₛₒ, in this order.

16. A method of manufacturing an optical compensation sheet according to claim 1, comprising:
coating a composition containing a liquid crystalline compound on a substrate having an alignment layer,
keeping the coated composition at a temperature of the liquid crystalline compound forming a liquid crystal phase to align the liquid crystalline compound in an aligned state to form a pre-layer of the optical anisotropic layer; and
fixing the liquid crystalline compound in the aligned state to form optical anisotropic layer,
wherein the keeping of the coated composition to align the liquid crystalline compound in the aligned state includes: aligning a discotic surface of the liquid crystalline compound substantially horizontally; and changing an alignment direction of the liquid crystalline compound along with a distance between the liquid crystalline compound and the alignment layer.

17. A polarizing plate comprising an optical compensation sheet according to claim 1.

18. A liquid crystal display comprising a polarizing plate according to claim 17.

19. The liquid crystal, display according to claim 18, wherein when a voltage for black display is set to be a voltage at which a transmittance of the liquid crystal display not containing the optical compensation sheet is within 1% to 10% relative to a white luminance in a voltage-transmittance curve of the liquid crystal display not containing the optical compensation sheet, a retardation of the optical compensation sheet and a bonding angle of the optical compensation sheet with a polarizer of the polarizing plate are controlled such that a black luminance is minimized at the voltage for black display.
